(19) United States
(12) Patent Application Publication
(10) Pub. No.: US 2012/0327001 A1
(43) Pub. Date: Dec. 27, 2012

(54) MULTI-GESTURE TRAMPOLINE KEYS

(75) Inventor: Timothy B. Higginson, Highland Park, IL (US)

(73) Assignee: Yuvee, Inc., Highland Park, IL (US)

(21) Appl. No.: 13/529,162

(22) Filed: Jun. 21, 2012

Related U.S. Application Data
(60) Provisional application No. 61/499,506, filed on Jun. 21, 2011.

(51) Int. Cl. G06F 3/041

(52) U.S. Cl. 345/173

(57) ABSTRACT

Composite structure trampoline key structures are described for use on top of a touchscreen or other touch, pressure, motion or gesture sensitive components. The aforementioned touch screen may be referred to as a pressure sensitive layer or PSL. The composite structure trampoline key array comprises a frame of one or more physical materials comprising of a perimeter structure and an internal array structure, the frame's function being to position the composite overlay in position in relation to the PSL and to hold a flexible fingertip material in place above the PSL and at a specified surface tension, and (2) a flexible fingertip material integral or attached to the frame which flexible fingertip material stretches in the open areas of the frame's array thereby providing the location for fingertip presses to activate the underlying PSL at specific locations.

### CROSS-REFERENCE TO RELATED APPLICATION

This application claims the priority benefit of Higginson, U.S. Provisional Patent Application Ser. No. 61/499,506, filed on Jun. 21, 2011, entitled “MULTI-GESTURE TRAMPOLINE KEYS,” the contents of which are expressly incorporated herein by reference in their entirety, including any references therein.

### AREA OF THE INVENTION

The present invention generally relates to a physical keyboard array that enables on a per-key basis multiple gestures in order to update traditional mechanical key arrays to create simplified and highly tactile responsive keys for next generation mobile and converged computing and text, command and data entry contexts.

### BACKGROUND

An increasingly important type of user input interface, with use across many types of devices, is a flat display with integrated touchscreen capability, frequently implemented to replace all or the majority of mechanical input keys. Some of the benefits of touchscreens are (1) the ability to recognize multiple types of finger gestures (e.g., single finger direct press, single finger swipes, multiple finger swipes, multiple finger direct presses, etc.), (2) the ability to reconfigure the display for different applications based entirely on software, and (3) the relative component simplicity achieved by removing the need for mechanical keys and any underlying components of mechanical keys such as membrane circuits and associated wiring

However, touch screen interfaces have many significant drawbacks. They are generally harder to use than physical, mechanical keys since flat surfaces provide no tactile differentiation for the user to orient where his/her fingers are to press to activate/select particular keys associated with certain input values, operational modes, and/or functions.

They also require a user to stop what they are doing, take their eyes off the media or graphical or text content and look directly at the user interface and then press precisely at a spot on the screen. This is contrary to “touch-typing” on a standard PC keyboard where the eyes are on the document and the fingers are on the keys; and, it is contrary to the concept of mobile devices where the user is “mobile” while at the same time using the device; it is disruptive of entertainment, media and gaming where the eyes must be taken off displayed media/game/entertainment content and graphics to look at the user input interface.

This lack of tactile differentiation can be a particular problem in handheld devices that are used when the eyes are looking elsewhere.

For many applications other than text and numeric entry, tactile differentiation of location of key presses is very important for the user experience. These include game controller contexts, camera picture taking, TV remotes and other contexts.

Further, the undifferentiated surface of these touchscreen interfaces poses a significant usability problem for the visually impaired user. This problem is highlighted by the voice-over accessibility solution that many of these devices incorporate in order to attempt to provide a useable device for the visually impaired user. Nevertheless, these voice-over solutions are highly problematic. They change the normal gestures that are at the core of the use of the device to a new gesture pattern that is more complicated and slower. Further, many of the third party applications that are available and a critical part of the user experience of these devices are not optimized for the voice-over capability, and hence are not usable by a visually impaired person.

Certain touch screen technologies also permit new types of gesture recognition, such as swipes, and multi-touch, that are not accommodated by mechanical keys and that add a new user experience dimension to users of touchscreen devices.

There are many benefits to tactile feel, of the type provided by previous mechanically actuated input key arrays, for user interfaces. One important benefit is that it allows for “touch-typing” usage; this means that the eyes can be on the upper screen or somewhere else other than on the user interface, and the user is able to operate the interface to a high degree of proficiency. In additional, tactile response adds a dimension to the user experience in its own right. Fingertips are highly attuned from a sensory perspective to surface textures and shapes. People like to click buttons. Children in science museums respond to buttons and other physical control surfaces, such as knobs and levers.

Further, tactile differentiation within a keypad allows for the user to distinguish by touch alone where the fingers are located/oriented to begin and continue accurately using the keys, and to distinguish among keys that have different purposes. Many keyboards for instance use a convex surface for the alphanumeric keys and a flat or slightly convex surface for the space bar. Most QWERTY keyboards have a raised physical nub on the “F” and “J” keys to for the user to orient their hands for proper two-handed typing, and most telephone keypads and calculators have a raised nub on the “5” key.

A significant ease of use problem with touchscreens is that it is inherently difficult to rest the fingers on the surface without activating the touchscreen sensors and, hence, initiating a command sequence on the device. This is particularly an issue with the way many touchscreens and control surfaces are implemented whereby each application is permitted to use the touchscreen surface entirely differently, providing the user no consistent usage patterns. This means that the fingers must be held raised above the screen, among other usability issues, resulting in a number of difficulties. The difficulties include: (1) finger and hand strain from holding the fingers above the surface, and (2) difficulty orienting the fingers over the right locations on the touchscreen.

In many devices with mechanical keys, the buttons allow the fingers to rest lightly on the keys, so the fingers are already in the right location to use the interface, and the mechanical key surfaces have touch orienting features, such as on a telephone keypad a raised nub on the “5 jkl” key and such as on QWERTY keyboards raised nubs on the “F” and “J” keys to enable the user to orient his or her fingers without looking at the keys. Computer mice also allow fingers to rest on the right and left clicks, and only activate them when the user presses on them. Flat touchscreens do not allow for these important ease of use features.

However, mechanical keys have drawbacks as well. For mobile devices, where the size of the overall device is a critical factor for users, there is a very difficult balance between size of device, size of display (size of “eyeball” experience) and the presence, if any, of mechanical keys. Some touchscreen devices include a set physical keys separately from the touchscreen display, but at least the current trend is to reduce the number of mechanical keys to an absolute minimum in order to maximize the “eyeball” experience of the device, as well as to reduce size, weight and component complexity.

Mechanical keys in mobile devices add complexity and cost to the manufacture of the device, and also generally reduce the size of the touchscreen in order to allow space for the physical keys. Keyboards integral to laptops and separate keyboards for desktop personal computers frequently incorporate mechanical keys, overwhelmingly in the layout known as “QWERTY”, potentially also with one or more sets of soft or function keys and possibly a set dedicated to a numeric keypad. These mechanical keys generally consist of multiple separate components. These components generally include a per-key plastic shell and spring assembly, an underlying membrane circuit and wiring, all set into the overall case of the keyboard or device. These mechanical keys are designed to accommodate only a vertical press of a pre-set travel distance, along with a consistent responsiveness to a certain amount of pressure by a fingertip.

A further drawback of mechanical keys has been the need to print labels on each key at the time of manufacture. This imposes additional steps and cost to the manufacturing process, incurs the risk of mis-labeled keys leading to increased returns and/or quality control checks. Further, as devices increasingly require a highly varied set of and types of input from the user (including in relation to subsequently-installed, third-party software applications), pre-labeling keys at the time of manufacture significantly limits the efficacy of the keys even if subsequent third party application developers can re-configure the input-to-application action effect of the press of a key because the user still sees the original labeling on the key, not the function of the key as altered to meet the needs of a software application.

Mechanical key solutions have generally been designed, manufactured and implemented in keyboards, keypads, mobile devices, remote controls, calculators and other devices in a manner that has been established for many years. This makes sense from a reliability, cost-of-component and cost-of-manufacture perspective and for a single purpose context (such as text entry in a single language) where the keys are pre-labeled at the time of manufacture, but is not providing an effective solution for new mechanical key systems, especially in the context that increasingly the demands for user input have changed radically from the time when a user primarily looked to the keyboard to enter text. With the advent of multi-application, multi-function devices such as mobile devices where the user is entering a vast suite of commands across a wide range of increasingly sophisticated third party applications many of which commands are entirely unrelated to text entry, and with web-enabled TVs, automobiles with a complex array of control functions, frequently presented on touchscreens requiring the driver to take his/her eyes off the road in order to select a mode control and data entry within that mode.

Some efforts at resolving some of these drawbacks are being made by integrating haptic feedback systems into touchscreen interfaces. These can include visual cues when the fingers are in the right location (such as by enlarging an icon when the finger is over it) or adding sounds when a press activates the touchscreen (imitating a physical key click sound), or by providing a vibrating or other sensation to the fingertip.

A method of maintaining the full flexibility of a flat touchscreen while allowing an option to the user to add a tactile feel has been developed around flip over or temporary, one-piece adhesive overlays, or overlays that are clipped-on or magnetically attached. These have generally not achieved a significant level of usability improvement over the basic touchscreen experience. These overlays add a level of complexity to the user's experience that is frequently not desirable, particularly in the context of the simplicity intent behind implementing a touchscreen user interface in a device in the first place. The user must either carry around the separate overlay, or the device must have it attached by a hinge or other mechanism. Further, the user must precisely orient the overlay in relation to the keys appearing by software on the touchscreen, which, in the case of an overlay that removably attaches is not a simple matter, and a small offset means that key presses on the overlay actually activate the wrong virtual key in the touchscreen software. Furthermore, an overlay may be optimized for one specific application's user interface layout, but may not be designed in any way to work across other applications with different user interface designs.

Other efforts to overcome the problems associated with these existing user interfaces' various limitations involve, for instance, voice recognition and remote gesture recognition. Each of these has its own set of drawbacks or limitations. Voice recognition, for instance, while increasingly technologically available, suffers from social and other constraints. For instance, it is problematic socially or from a business perspective to dictate out loud a private text message while in public, such as on a commuter train, in a business conference room, etc. Gesture recognition similarly requires a public display of motion that may or may not be appropriate in various contexts.

### BRIEF SUMMARY OF THE INVENTION

The aforementioned shortcomings of existing touchscreen interfaces, overlays and other technologies for accommodating those shortcomings on touchscreen devices and the shortcomings of mechanical keys is addressed by composite structure trampoline keys for use on top of touchscreen or other touch, pressure, motion or gesture sensitive components. Hereinafter, the aforementioned touchscreen or other touch, pressure, motion or gesture sensitive component shall be referred to as the “pressure sensitive layer” or “PSL”.

The composite structure trampoline key array comprises (1) a frame of one or more physical materials comprising a perimeter structure and an internal array structure, the frame's function being to position the composite overlay in position in relation to the PSL and to hold a flexible fingertip material in place above the PSL and at a specified surface tension, and (2) a flexible fingertip material integral or attached to the frame which flexible fingertip material stretches in the open areas of the frame's array thereby providing the location for fingertip presses to activate the underlying PSL at specific locations.

The frame holds the flexible fingertip material a certain distance above the touchscreen and at a specified tension, thereby allowing fingertips to rest on the composite keypad structure without activating the PSL unless the user presses a fingertip into the flexible fingertip material with sufficient pressure and distance to place the flexible fingertip material in sufficient contact with the PSL to activate the sensors in the PSL component.

Composite overlays can be manufactured with the flexible fingertip material of varying heights above the touchscreen surface and of varying tension or resistance to fingertip pressure.

The flexible fingertip material comprises a material recognized by the touchscreen surface as one that activates the PSL sensors. The frame structure of the composite key array consist of material that does not activate the PSL sensors, thereby allowing portions of the frame to be in contact with the surface of the PSL without causing any activation (and/or, the software operating the PSL can be programmed so as not to acknowledge pressure at the location of the frame's contact with the PSL as an activation event).

The composite key array works in conjunction with software that defines the surface area of the PSL located under the flexible fingertip material as performing a function when the flexible fingertip material above that area is depressed by a fingertip so as to contact that surface area in a single point or as a swipe across that surface area at various starting and ending points, which swipe may also be measured by direction, speed and duration, individually or in combination, as well as singly or in combination with presses of other fingertips on others of the array's fingertip press material areas.

The composite overlay key array structure combines the benefit of the tactile differentiation and sensory perception of physical keys with the mechanical simplicity of composite material manufacturing and reconfigurability and the multi-gesture user experience of touchscreens. The composite overlay structure can be cost-competitively manufactured using 3D printing systems, including printing one or more or the entirety of the various composites (frame, frame arrays and flexible materials) in a single printing process to produce a single key incorporating different plastics or metals according to varying the materials used in the printing process. An alternative is to print the frame structure and lay separately manufactured clothe-type flexible fingertip material into the frame during the frame printing process. Another alternative is to use the traditional plastic mold manufacturing process for the producing the frame, followed by a component integration process whereby the frame component(s) and the flexible fingertip material are combined into the final product.

The frame and flexible fingertip materials are constructed and arranged in arrays that may incorporate different numbers of flexible fingertip material areas, different sizes and constructs of frames, different frame and/or flexible fingertip material area shapes, and with clear or colored or opaque flexible fingertip material and with or without molded or painted or sprayed on or otherwise manufactured surface texture and shapes for the frames and/or the flexible fingertip materials. The options chosen for the design any specific array will depend on the context. For instance, for a standard QWERTY keyboard peripheral device for a personal computer, the number of flexible fingertip material areas would be a sum of the twenty-six letters of the English alphabet, plus a set of function keys at the top of the keyboard array, plus a set of standard text entry keys (e.g., caps lock, enter, one or two shift keys, space, home, end, function, control, tab, up/down/left/right arrows, additional punctuation keys, potentially separate numeric keys associated with a ten-key calculator layout, etc.). For such a QWERTY keyboard, the array six, parallel horizontal rows of keys, but the array would not include parallel vertical columns, but instead, in each row the keys would be offset from the keys in the row above and below. Further, for such a QWERTY keyboard, certain of the flexible fingertip material areas would be of a larger or smaller dimension than that area for the alphabet keys, such as, for example, the space, shift and enter keys. Another example would be for a NeoKeys-based keypad layout, a five column by four row array wherein each of the flexible fingertip material areas of the keys in the middle three column by four row array are of an identical shape and size, and the keys in the left-most and right-most columns are of an identical shape and size (but different from those of the middle three column by four row array keys), with an optional set of from one to six additional flexible fingertip keys arrayed in a line or arc below the five column by four row array.

The construction and operation of the multi-gesture, trampoline key array does not require any wired or wireless electronic components, any power supply or any wired signal or power connections of any kind. By requiring no power supply, the key array has no impact on the battery life of a device to which it is removably attached or into which it is constructed, and, furthermore, by not requiring any internal or external electronic wired connections, the manufacturing process is simplified, and cost of components is reduced.

The flexible fingertip material's properties of resistance to downwards pressure and durability can be varied by the type and depth and other physical properties of the materials used during manufacture of the overlay.

The flexible fingertip material's properties allow for contact on the touchscreen either as a single, direct press or in the context of multi-touch (i.e., simultaneous touch from among multiple of the array elements of flexible fingertip materials) and in the context of motion gestures within each flexible fingertip material area, such as downward pressure combined with a vertical, horizontal or arced swipe, each potentially also measured according to time duration of contact and/or speed of motion during contact across the surface area of the PSL.

The patterns and shapes and active or flexible fingertip material areas associatively relate to the software graphics shown in an electronic display that is either a separate component along with the PSL or integral to the PSL, such as if the PSL is a touchscreen component. By tight coordination among the flexible fingertip material features and a software application that controls a specific area of the PSL, that active area of the PSL can be defined by the software to be very small in size and other activation characteristics because the flexible fingertip material can be designed to press only that area, whereas with direct finger tip activation, the software must accommodate for a wider size range and activation characteristics due to the variable size of finger tips and the many possible ways users may attempt to press on an area of the screen to activate some feature of the software.

Furthermore, a tight alignment between the multi-gesture trampoline keys' array and a set of software developer guidelines, such that all software applications conform their user interface to the keys' array, provides the user with a predicable, consistent pattern of use across all applications, with the user interface located at a specific location on the PSL that permits the development of muscle memory and other aspects contributing to ease of use of devices through their user interface. (This, for instance, solves the ease of use problem of a “floating” mini-QWERTY virtual keyboard that appears at different locations on the touchscreen depending on what other applications and/or content and media are also on the touchscreen display at the time and for which the virtual keyboard is being used to enter data.).

The multi-gesture, trampoline key structure can be separately manufactured from the underlying device incorporating the PSL, such as a touchscreen-based device. The key array structure, in that instance, is removably attachable to the PSL device by way of various attachment methods designed into the external frame of the key array structure. Alternatively, the multi-gesture, trampoline key structure is integrally constructed with a case also containing the PSL and its associated power supply and electronic components, such as for a stand-alone wireless or wire-connected keyboard or keypad.

The multi-gesture, trampoline key array is aligned to a software-generated image conveying a function value associated with pressing each flexible fingertip material, which software-generated image is displayed in relation to each flexible fingertip material area such that a user associates the function value with a specific flexible fingertip material. An example is an implementation of the NeoKeys user interface wherein each row of flexible fingertip material keys has a display above it on which the function value of each key is displayed above each key.

This type of key array can be implemented in stand-alone keyboards and keypads that are connected on a wired or wireless basis to another device such as a personal computer tower, a television set, a wireless router a tablet personal computer or other device. Similarly, this type of key array can be structurally integrated to replace standard construction physical keys, such as in desktop keyboards, TV or cable remote controls, remote controls for other devices, keypads in cars, keypads in kitchen devices such as microwaves or refrigerators, keypads on exercise equipment, etc. Additionally, this type of key array can be sold separately, and be removably attached to touchscreen devices such as tablet personal computers and touchscreen mobile phone and mobile computing devices.

This type of key assembly allows for lighter weight keypads and keyboards, and keypads and keyboard assemblies that are smaller in dimension than many standard physical key assemblies.

### BRIEF DESCRIPTION OF THE DRAWINGS

While the appended claims set forth the features of the present invention with particularity, the invention and its advantages are best understood from the following detailed description taken in conjunction with the accompanying drawings, of which:

FIG. 1 is a top view of a four-by-four array key assembly of a multi-gesture, trampoline keypad.

FIG. 2a is a side, cut-away view of a single multi-gesture, trampoline key assembly.

FIG. 2b is a side, cut-away view of a multi-gesture, trampoline key assembly integrally installed with the case of a device.

FIG. 3 is a top view of a single multi-gesture, trampoline key with a single trampoline material located across the open area within the key frame.

FIG. 4 is a side, cut-away view of a single multi-gesture, trampoline key with a single trampoline material located across the open area within the key frame.

FIG. 5 is a side, cut-away view of a single multi-gesture, trampoline key assembly showing with a multi-component frame.

FIG. 6 is a top-view of a two-row, eight multi-gesture trampoline key assembly that incorporates viewing panels interspersed in the frame above each of the rows, and with square keys.

FIG. 7 is a top-view of a two-row, eight multi-gesture trampoline key assembly that incorporates viewing panels interspersed in the frame above each of the rows, and with round keys.

FIG. 8 is a side, cut-away view of a single multi-gesture, trampoline key assembly showing with a multi-component frame, and showing a physical nub at the center of the trampoline material component.

FIG. 9 is a side, cut-away view of a single multi-gesture, trampoline key assembly showing with a multi-component frame, and showing a physical nub at the center of the trampoline material component, wherein the physical nub has curved surfaces above and below the trampoline material.

FIG. 10 is a top-view of a two-row, eight multi-gesture trampoline key assembly that incorporates viewing panels interspersed in the frame above each of the rows, and with square keys, wherein each key's trampoline material has a circular cut-out at the center of the material.

FIG. 11 is a top-view of a two-row, eight multi-gesture trampoline key assembly that incorporates viewing panels interspersed in the frame above each of the rows, and with square keys, wherein each key's trampoline material has a circular physical nub at the center of the material.

FIG. 12 is a top view of a single multi-gesture, trampoline key assembly depicting the center feature of the trampoline material located in different positions according to the directional finger pressure of a user's finger on the center of the trampoline material.

FIG. 13 is a side, cut-away view of a single multi-gesture, trampoline key assembly depicting the trampoline material integrated into a frame and depressed by a user's finger pressure such that the bottom of the trampoline material contacts the top surface of a PSL.

FIG. 14 is a side, cut-away view of a single multi-gesture, trampoline key assembly depicting the trampoline material integrated into a frame and depressed by a user's finger pressure such that the bottom of the trampoline material contacts the top surface of a PSL.

FIG. 15 is a side, cut-away view of a single multi-gesture, trampoline key assembly depicting the trampoline material integrated into a frame and depressed by a user's finger pressure such that the bottom of the trampoline material contacts the top surface of a PSL.

FIG. 16 is a side, cut-away view of a single multi-gesture, trampoline key assembly depicting the trampoline material integrated into a frame and depressed by a user's finger pressure such that the bottom of the trampoline material contacts the top surface of a PSL.

FIG. 17 is a side, cut-away view of a single multi-gesture, trampoline key assembly depicting the trampoline material integrated into a frame and depressed by a user's finger pressure such that the bottom of the trampoline material contacts the top surface of a PSL.

FIG. 18 is a top view of a two-row, eight multi-gesture, trampoline key assembly in a device that is attached (wired or wirelessly) to a second device which itself is attached (wired or wirelessly) to a device with a display.

FIG. 19 is a top view of a two-row, eight multi-gesture, trampoline key assembly with integrated viewing component in a device that is attached (wired or wirelessly) to a device with a display.

FIG. 20 is a top view of a two-row, eight multi-gesture, trampoline key assembly in a device that has a separate, integrated display.

FIG. 21 is a top view of a single multi-gesture, trampoline key assembly wherein the trampoline material comprises radially-organized bands each attached at one end to the frame and at the other end to a physical nub.

FIG. 22 is a top view of four row array of multi-gesture, trampoline keys wherein each row has six individual multi-gesture, trampoline keys, and where the keys in each row have different shapes and sizes of frame and trampoline material, and wherein there is a viewing display area above each row.

FIG. 23 is a side, cut-away view of a single multi-gesture, trampoline key assembly wherein there is a physical nub that is slideably attached to a single band trampoline material.

FIG. 24 is a side, cutaway view of a physical nub that has holes for being slideably attached to a two-band trampoline material key assembly.

FIG. 25 is a top view of a single multi-gesture trampoline key wherein a single band of trampoline material is attached to a frame.

FIG. 26 is a side, cut-away view of a multi-gesture, trampoline key assembly wherein the PSL component has a curved surface, and the key assembly follows the curvature of the PSL surface.

### DESCRIPTION OF ILLUSTRATIVE/EXEMPLARY EMBODIMENTS

The General Arrangement

Attention is directed to a set of associated figures that follow this description. The figures illustratively depict multi-gesture, trampoline keys and keyboards.

The figures show one or an array of multi-gesture, trampoline keys designed to be overlaid, permanently attached to and/or removably attached to, the surface of a PSL (e.g., a touchscreen or other component with a surface that recognize touch, pressure or downward or gesture-controlled motion), which set of multi-gesture, trampoline keys requires no wired or wireless electronic connections or power supply.

In the figures, the keys comprise one or more frames comprising of various rigid or semi-rigid materials, which frames surround the exterior perimeter of the entire key structure and also provide internal framing around each individual key, such that a flexible material is held in place over each fingertip area of each key in both a vertical dimension above the surface and in relation to all the other keys and a set surface tension designed to allow a fingertip to rest on the surface of the flexible material without depressing the flexible material to the extent that it contacts the PSL, and which tension is further designed (a) to permit intentional downward depression with pressure exerted by a fingertip consistent with the resistance used by standard mechanical keys on a standard QWERTY keyboard and furthermore (b) to provide the upward return motion of such standard mechanical keys.

The frame structure supporting the flexible fingertip material consists, vertically, of a lower frame layer, a middle layer of the flexible material and a top frame layer. Furthermore, the flexible fingertip material may incorporate a central feature providing tactile orientation on the top (fingertip-side) of the flexible material and a contact surface on the underneath side of the flexible fingertip material.

Many materials are available for the frames and for the flexible fingertip material. For most consumer and business product applications, the frames are constructed in the same manner and using the same polycarbonate plastic as used in standard desktop keyboards cases, TV/cable remote control cases, and/or mobile phone cases. The manufacturing process is identical to that used for these current device casings, including the computer-aided design work to create a virtual 3D model of the case and its various components, followed by the construction of a mold whereby the polycarbonate plastic is injected into the mold to create the components of the case and/or frame components.

Further, many different types of touch, pressure, finger or motion or gesture sensitive surfaces are available. An example is the mutual capacitive touchscreen used in Apple's iPhone 4 which allows recognition of single and multi-finger touches as well as multi-gesture recognition (e.g., single finger presses, multi-finger pinches in/out and single and/or multi-finger swipes).

Additionally, there are many existing packages of software for operating translating a finger press resulting in contact (whether instantaneous, or of a certain duration, and whether at a single point of contact or directionally across a range of the surface of the PSL, and whether as a sole key press or as part of a simultaneous press of multiple flexible fingertip materials) of the flexible fingertip material to the PSL into a system or application commands.

Many materials are available for the flexible fingertip material. A woven fabric of high carbon polypropylene with high tensile strength is sold by companies for use in trampolines of various dimensions by such companies as Lancer Textiles (with a location in Elkins Park, Pa. 19027) and Tencate Industries (with a location at 7600 GD Almelo The Netherlands) which provides a fabric that flexes and that returns to a flat position and does not stretch. As an example alternative to such a woven fabric for use in the flexible fingertip material, a web of individual strings is implemented. Examples of the materials of which such strings are made are those manufactured and sold by companies providing strings for tennis, badminton or other racquet sports and/or musical instruments such as guitars, mandolins, harps and other string instruments, which strings are designed to be held taught in position relative to a frame, and to flex under pressure and return to their original position on release of that pressure. The most salient factors in such example strings are their material composition; other technical specifications such as cross-sectional dimensionality will vary depending on the size of the key in which the strings are being used.

For a touch surface layer constructed with a mutual capacitive touchscreen, the flexible fingertip material is painted on the underside with a layer of silicone (or other material) that mimics the natural conductive qualities of the human finger. Examples of such silicone-based products that activate touchscreens in place of direct fingertip contact are the engagement tips of the “Pogo” and “soft-touch” styli sold by Apple for use with its iPhone, iTouch and iPad touchscreens. For the embodiments of this invention wherein a center nub piece is used to create a fine-tuned contact point with the PSL layer, the center nub piece is manufactured of such silicon material.

The dimensions of the key assembly and the individual keys varies depending on the device context. For a full, desktop QWERTY keyboard or a QWERTY keyboard integrated into a laptop computer, the surface area dimension of the flexible fingertip material area for the alphabet-labeled keys is approximately 15 mm in width by 15 mm in height for a square key with the flexible surface area approximately 2-to-4 mm above the PSL depending on the desired travel distance for the keys. An example of the NeoKeys layout is provided in Higginson, U.S. Pat. No. 6,703,963, the contents of which are incorporated by reference herein in their entirety, including any references therein.

The dimensions for a keypad based on the NeoKeys user interface the overall dimension of the keypad device is approximately 91 mm wide by 114 mm high by 27 mm in depth at the end away from the user and 18 mm in depth at the end closest to the user (i.e., nearest to the wrist of the user), with the depth measurements inclusive of the feet of the device. For such a key layout, the middle array of keys consists of a four row by five column array containing 20 keys. Each of the 20 keys has a flexible fingertip surface area of 5 mm wide by 5 mm high, surrounded by internal frames for each key and an external frame of the dimensions of the device, and wherein the internal frames do not rise above the surface of the flexible fingertip material or do so by approximately one mm and, in the implementation with a central, physical nub at the center of each fingertip surface area, the nub rises above the level of the surrounding internal frame by at least one mm. In an alternative embodiment of this type of keypad, the middle four row by three column array of that device have a flexible fingertip surface area larger than that of the left hand and right hand four row by one column arrays of four keys. The set of 20 keys described above for this keypad device has a width, inclusive of frame, of approximately 90 mm and a height of approximately 70 mm.

For mobile, portable and handheld devices, the travel distance of the central contact point on the underneath side of the flexible surface material (and/or central physical nub, to the extent incorporated with the flexible surface material) to the PSL is approximately two mm, albeit that this travel distance varies depending on the device's intended purposes that will determine the travel distance, such as need for speed of contact and other user-preference specifications.

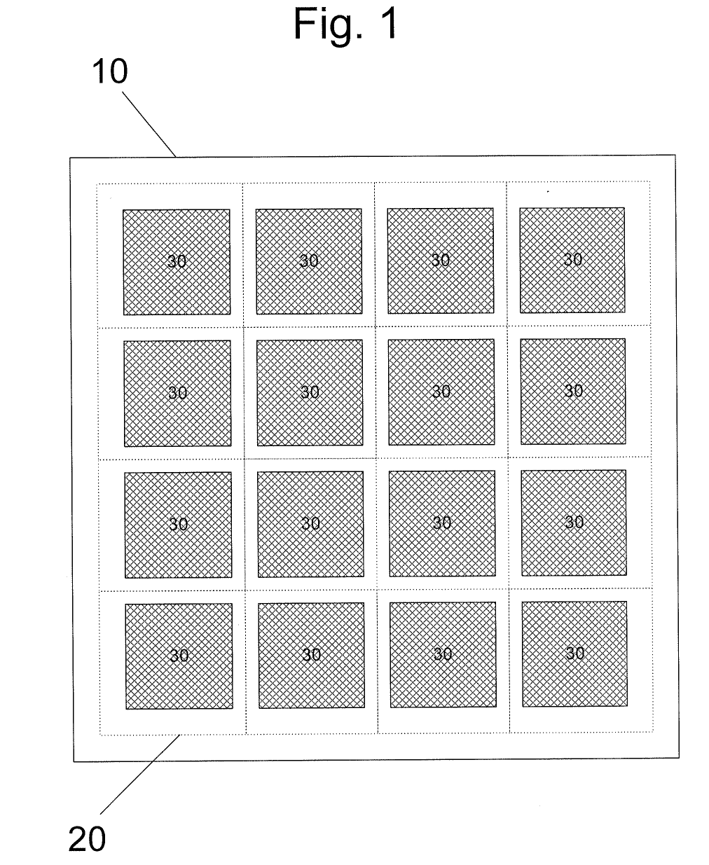

FIG. 1 is a top view of an assembly of a set of keys each with a fingertip material 30 and a key-specific frame area 20 and a single external frame area 10. The external frame performs multiple roles, including (a) providing structural stability for the internal frames for the combination internal frame/flexible fingertip material, and (b) providing the entire assembly's attachment or integration point to an underlying set of components, such as the PSL or a device case.

The internal frames surrounding each flexible fingertip material perform multiple roles, including (a) providing the attachment point and support structure for the flexible fingertip material, and (b) providing the user with a tactile locator differentiator for the location of each of the flexible fingertip materials in relation to each other and to other portions of the internal and external frame. The internal frames attachment point for the flexible fingertip material holds that flexible surface (a) taught, (b) a specified vertical distance above the touch-sensitive surface below the flexible fingertip material.

The flexible fingertip material (a) allows a user to rest a finger on the flexible material at a light pressure without deforming the surface sufficiently to have the PSL surface below recognize a touch gesture or key press, (b) permits the user to tactilely (without visually referencing the location of the keys) to align the user's fingers on multiple of the flexible surfaces on a resting basis and to move multiple fingers quickly across or among and depress multiple of the flexible material surfaces sequentially and/or simultaneously, (c) allows the user to activate a PSL area located underneath a flexible material surface by increasing the pressure of a fingertip sufficiently to deform the flexible material downwards (directly or across) the PSL area located beneath the flexible surface, and (d) allows a fingertip motion in multiple directions across the PSL surface area below the flexible material, thereby allowing multiple, single fingertip gestures to be recognized by the underlying system.

This permits the user to rest his/her finger on the flexible fingertip material which holds the finger above the PSL beneath the finger, and only activate the active the area beneath the finger by affirmatively pressing down with the fingertip to put the flexible fingertip material in contact with the active PSL area related to and activated by that flexible fingertip material, thus permitting touch-typing with fingers resting on physical surfaces on a PSL and allowing multiple types of gestures to be recognized.

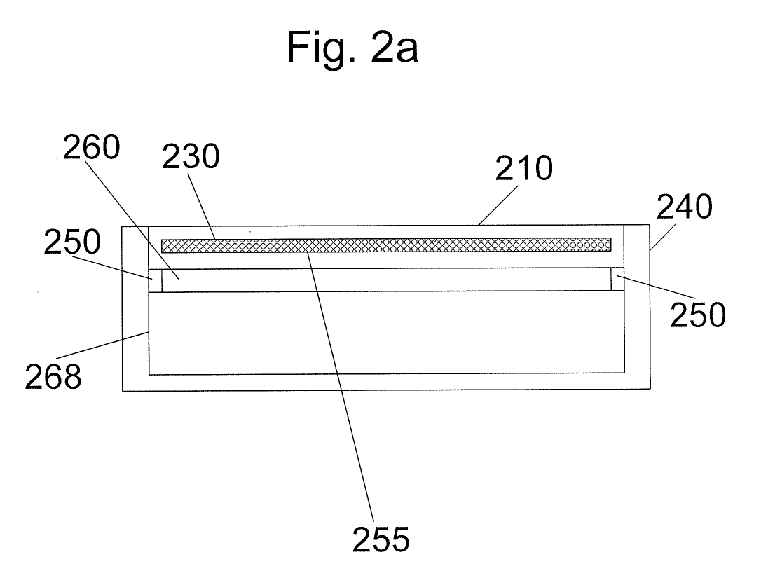

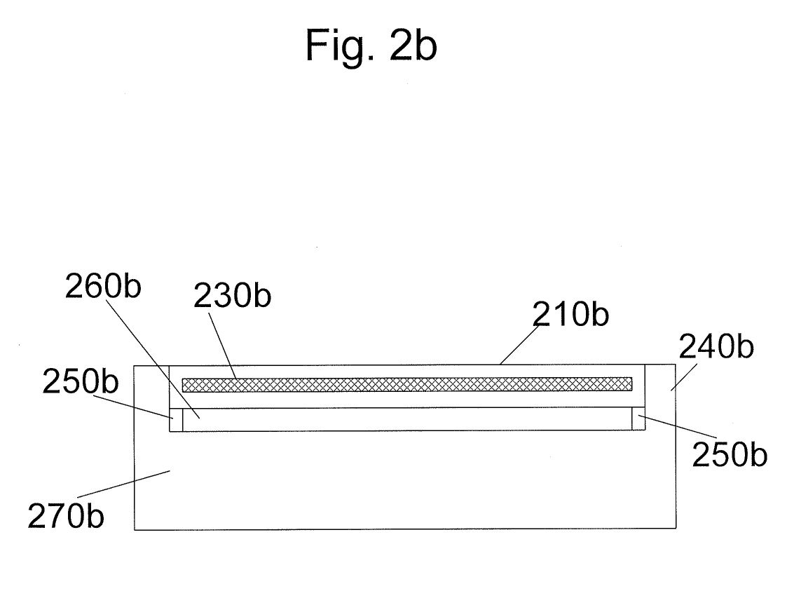

FIG. 2a is a side cut-away view of a device or device case 268 with a single touch or pressure sensitive surface (PSL) component 260 (and the non-active surface of that component 50), together with an external frame 240, an internal frame 210, and a flexible fingertip material 230. In this instance, the flexible fingertip material is shown as a single component stretched across all the internal frames. For the PSL component 260 that is a touchscreen designed to recognize finger tip contact, the flexible fingertip material 255 is coated with or consists of a layer of material that mimics the natural conductive qualities of the human finger.

FIG. 2b is a side cut-away view of a device case 270b with a single touch or pressure sensitive surface (PSL) component 260b (and a non-active surface of that component 2501), together with an external frame 240b wherein the external frame 240b is integrally constructed into a device case 270b, the internal frame 240b, and the flexible fingertip material 230b. In this instance, the flexible fingertip material is shown as a single component stretched across all the internal frames. The device case can be any device, such as a stand-alone keypad or keyboard, a smartphone, a tablet or laptop, a remote control, etc.

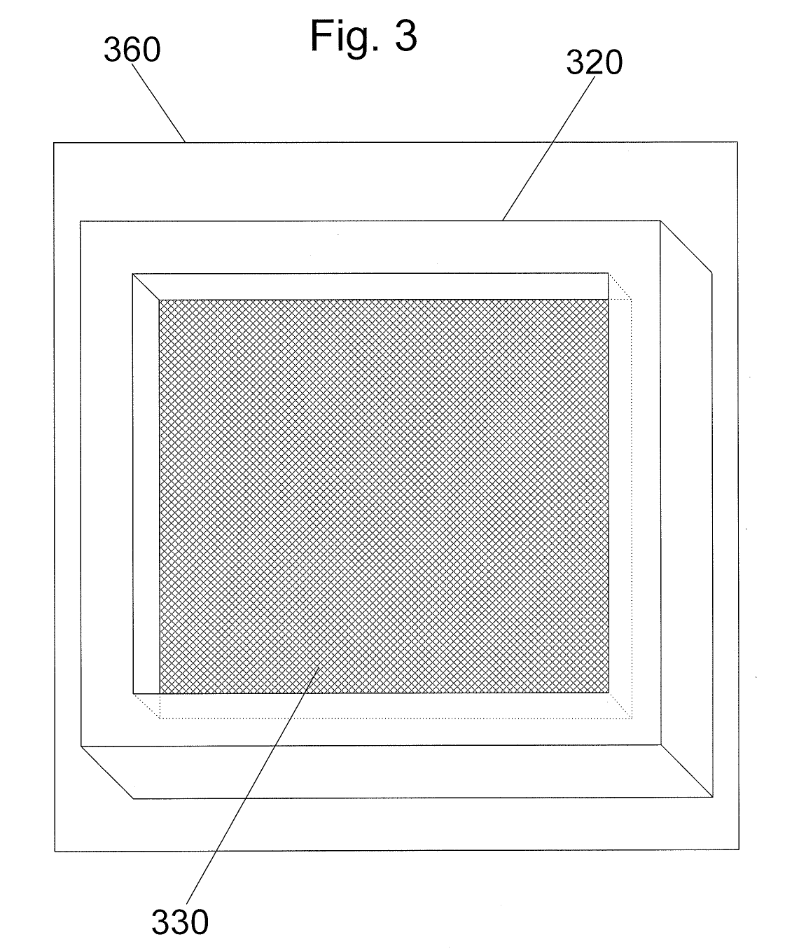

FIG. 3 is a top view of a single key structure comprising of a touch or pressure sensitive surface component 360, an external frame 320 for a flexible fingertip material 330. The flexible fingertip material 330 is shown located below the upper edges of the external frame 320, thereby providing both a structural solidity and a tactile locator differentiator between multiple of these keys.

The external frame's upper edges are higher in elevation above the flexible fingertip material than the internal frame's upper edges, and, in certain implementations, the internal frame is located entirely below a single sheet of the flexible fingertip material.

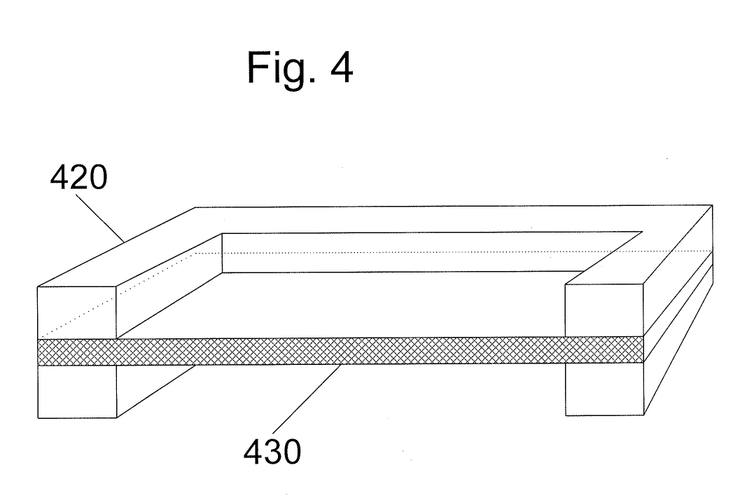

FIG. 4 is a side view of a single key structure wherein a flexible surface 430 is shown to be held by an external frame 420 to be both below the perimeter frame's upper surface of the key assembly and above the perimeter frame's lower surface of the key assembly. This permits the user to rest a finger on the flexible surface 430, and only activate the touch or pressure sensitive surface (PSL) below it by sufficient downward (vertical or angled and with or without a swipe gesture) pressure of the fingertip.

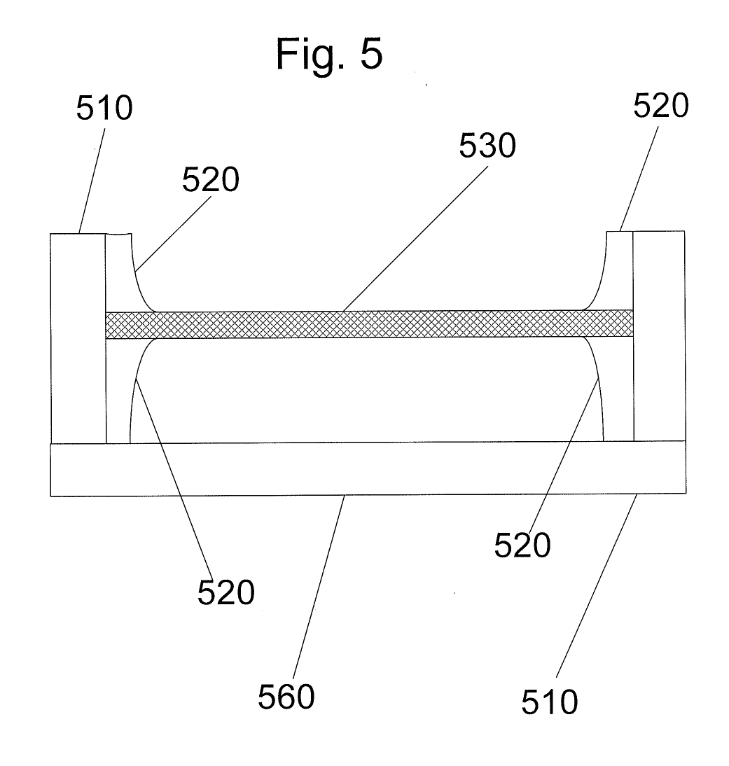

FIG. 5 is a side cut-away view of a single key structure with a flexible fingertip material 530, a touch or pressure sensitive/activated (PSL) component underneath 560, and a frame assembly comprising of an external strata 510 and internal strata 520.

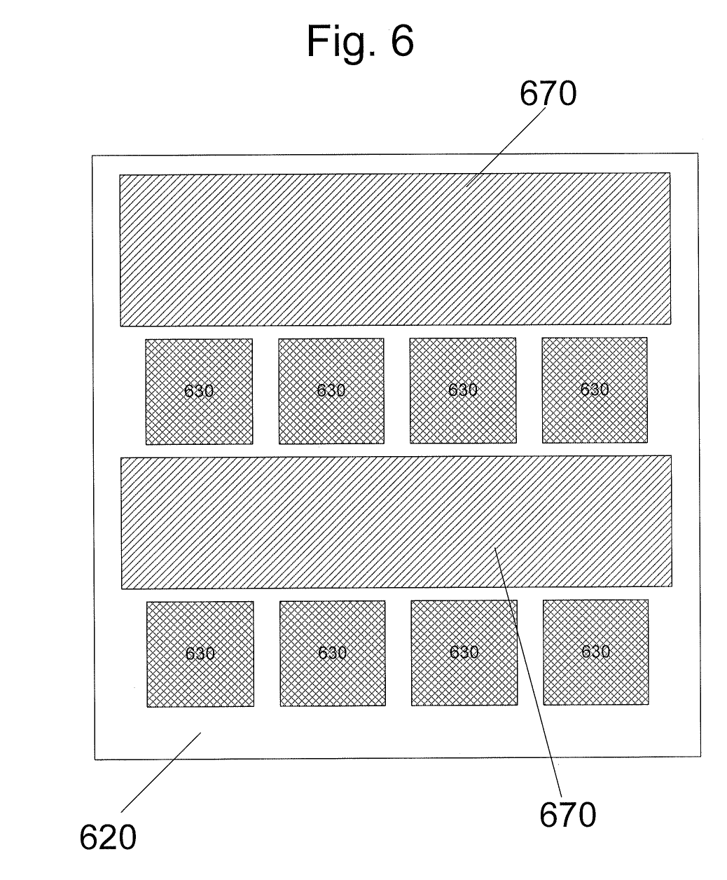

FIG. 6 is a top view of a multi-gesture trampoline key array wherein two rows of keys 630 are positioned inside a frame 620 that has two empty viewing panes 670 that provide a viewing area to display(s) located below the key array structure. The display(s) located below the frame consist of one or more displays, such as touchscreen LCDs or non-touchscreen LCDs. Alternatively to LCDs, and display component such as OLEDs, electronic ink or otherwise can be used depending on the cost and specifications for the display components required for the product. Further, these display panel(s) can extend as a single assembly under the area of the frame including the flexible fingertip areas 630, or, in an alternative embodiment, the displays can be two separate display components that do not extend into the areas underneath the flexible fingertip areas 30 where separate touch or pressure sensitive components are located.

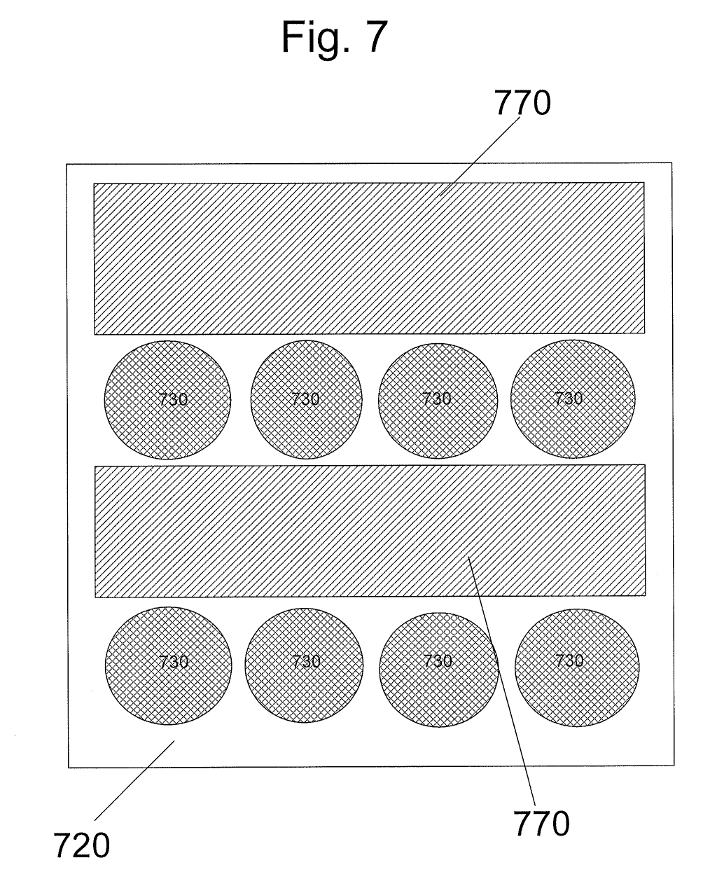

FIG. 7 is a set of round flexible fingertip materials 730 and an adjacent perimeter frame 720. The circular form permits an even distribution of location of fingertip area in contrast to a square or rectangular format for the flexible press material area and associated frame. Further, the circular design of the flexible fingertip material permits a larger internal structural frame at the intersections of the corners of the internal frames, thereby adding structural integrity to the key array assembly.

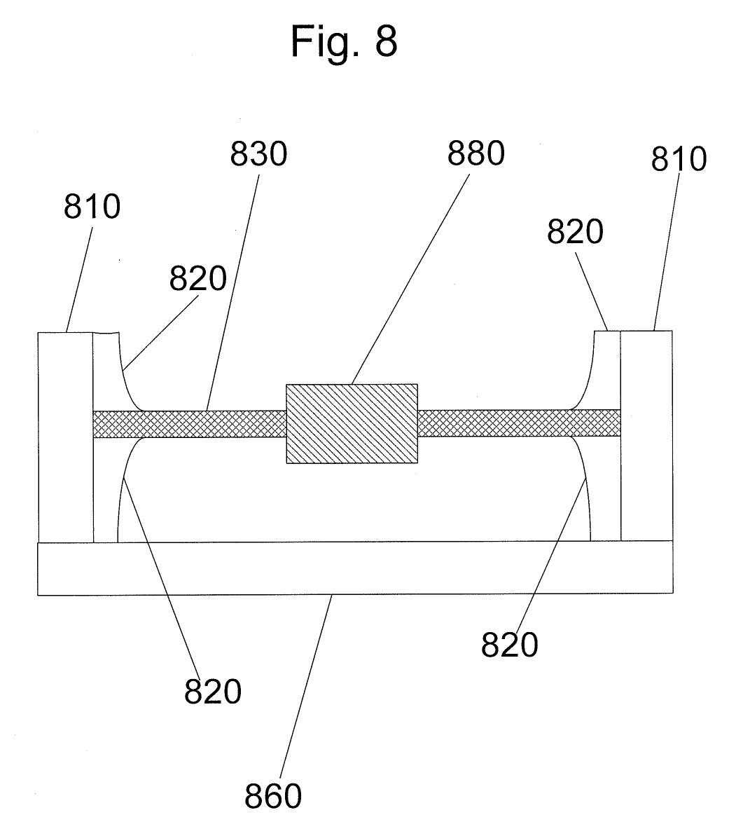

FIG. 8 is a flexible key assembly wherein an external frame 810, an internal frame 820, an underlying PSL components 860, and flexible fingertip material 830 are present, and a center non-flexible component 880 is integrally constructed or attached to the flexible fingertip material 830 which center non-flexible component 880 extends above that material 830 and below that material 830. This extension above provides an additional tactile point of reference for the fingertip as well as a lever for the fingertip to move the flexible material in multiple directions swiping across the top surface of the PSL 860. The extension of the center component 880 below the flexible material provides a contact point with the PSL component 860 that is precise in area and location (versus a fingertip which may present a variety of touch profiles depending on the size of the fingertip and the amount of downward pressure exerted by the finger).

The software coded to operate the touch or pressure sensitive component 860, whether the core operating system code or an application-specific code, can be configured to optimally recognize on a per-pixel (or other measurement basis) the lower surface area dimension of the center component 880, thereby providing highly accurate positioning and motion detection of a finger press for determination of the type, start location, end location and duration of a finger press on the key

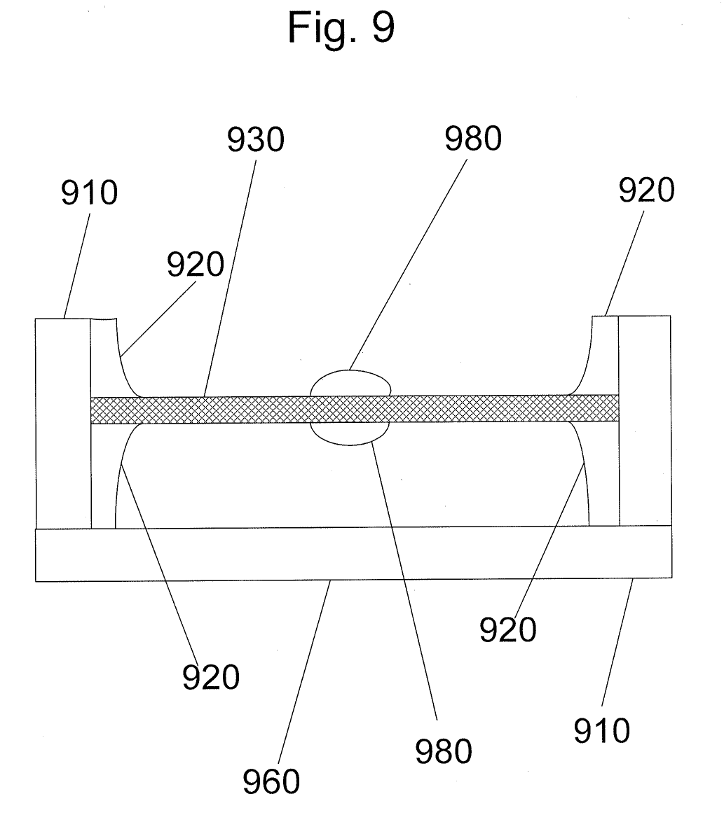

FIG. 9 is an alternative, asymmetrical embodiment of the central component 980, wherein the form of a central component 980 above a surface of a flexible fingertip material 930 is domed on top (and, not shown, circular in top-down view), and the form of the central component 980 below the surface of the flexible fingertip material 930 is somewhat larger in diameter (and, not shown, circular in top-down or bottom-up view) and domed (on the bottom) to provide a smaller surface area point of contact with an underlying PSL component 960.

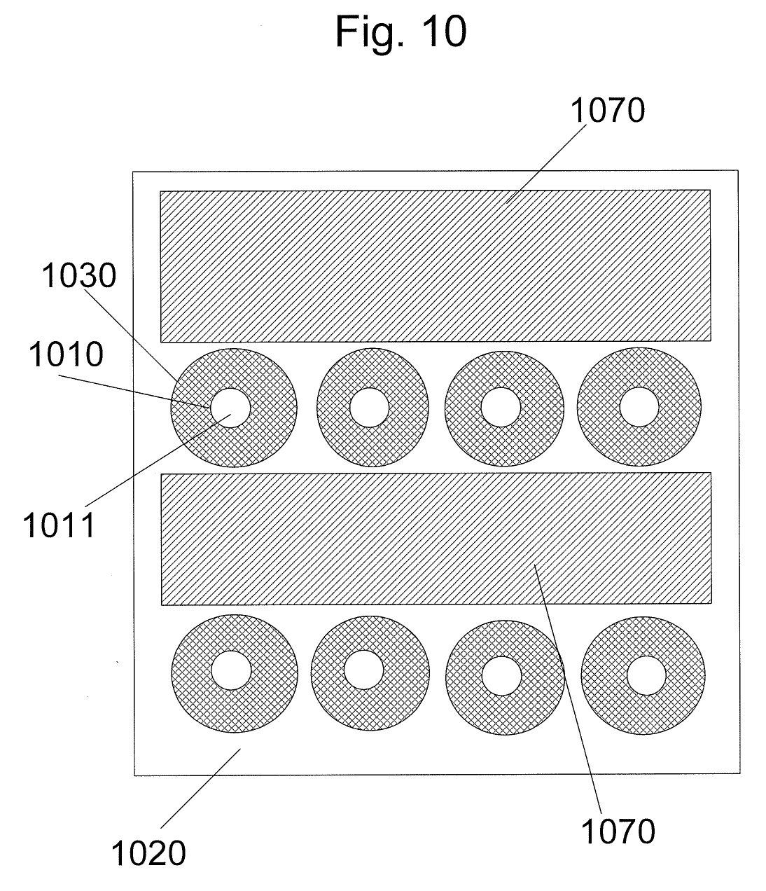

FIG. 10 is an alternative embodiment wherein a flexible finger press material 1030 is constructed such that a hole 1011 is in the middle, and an edge 1010 of the hole is finished with a circular rim. This embodiment provides an alternative way for the fingertip to tactilely determine the center of the flexible fingertip material as well as providing contact of the fingertip directly on the underlying PSL component's surface.

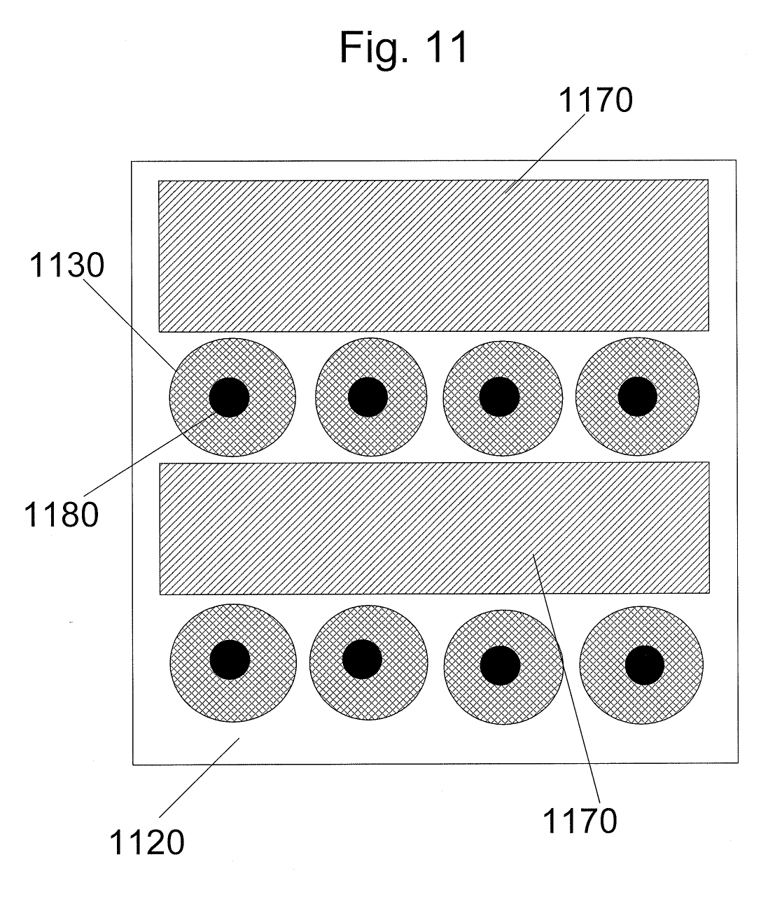

FIG. 11 is a top view of a key assembly wherein a circular, non-flexible component 1120 (similar to the component 880 described in FIG. 8 and the component 980 described in FIG. 9) is located at a center of each flexible fingertip materials 1130 on each of the keys in the key assembly frame 1120.

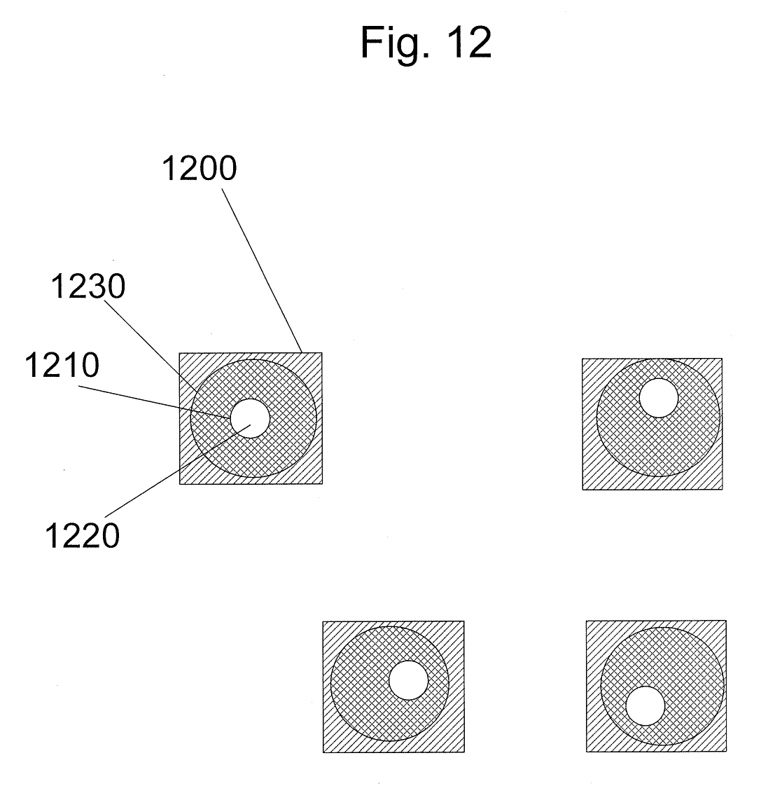

FIG. 12 comprises four top views of a single key external frame 1200, a flexible finger press material 1230, a central hole 1220, and a structural rim 1210, which rim is integrally a part of the flexible finger press material. The first view (with the central hole 1210 located in the center position of the circular flexible fingertip material 1230) displays the flexible fingertip material not stretched in any lateral direction by fingertip pressure. Each of the other views, shows the central hole 1220 located off-center with the flexible fingertip material stretched along vectors associated with the motion of the fingertip from the center location of the hole 1220 to the location of the center hole 1220 in it is non-center location. As this is a top-view, this FIG. 12 does not show the deformation of the flexible fingertip material downwards towards the PSL component's surface area below the flexible fingertip material.

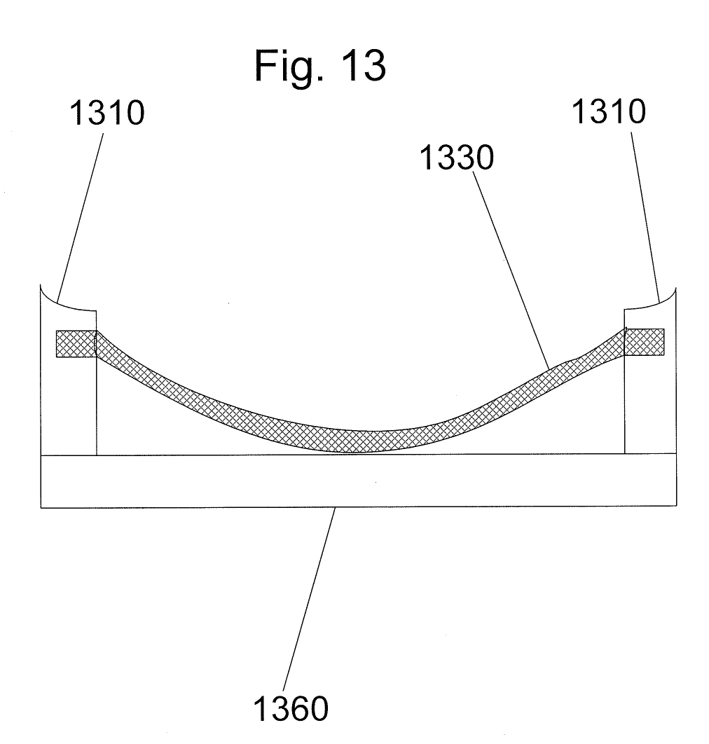

FIG. 13 is a side, cut-away view of a single key wherein a flexible finger press material 1330 is pressed downwards to contact a PSL component 1360 and wherein a frame 1310 in which the edges of the flexible fingertip material 1330 are embedded is depicted with a convex top and the flexible fingertip material 1330 structurally partially embedded within the frame 1310, and the frame extends above the surface of the flexible finger press material 1330 and holds flexible finger press material so that in that material's unpressed state the underlying surface of that material is positioned above, and nowhere in contact with, the surface of the PSL component 1360.

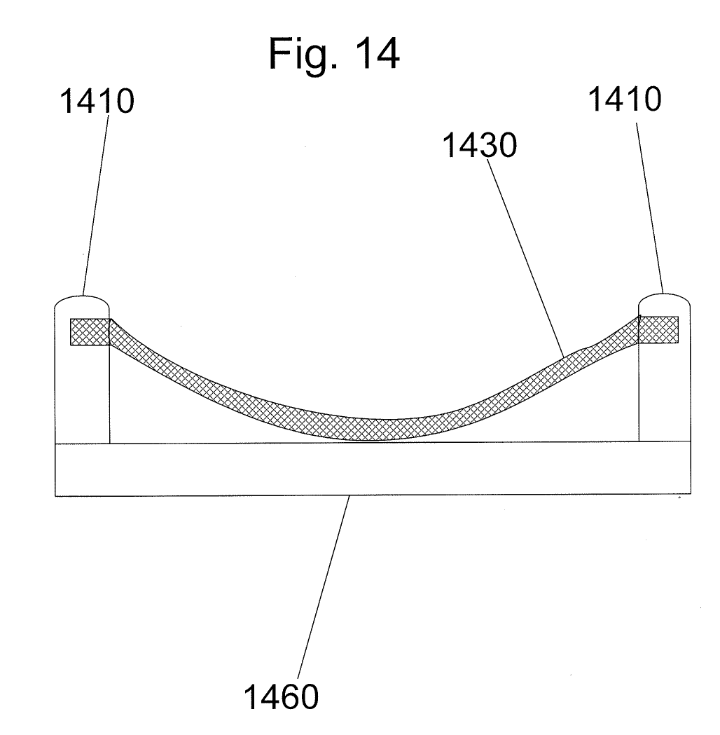

FIG. 14 is a side, cut-away view of a single key wherein a flexible finger press material 1430 is pressed downwards to contact a PSL component's 1460 surface, and wherein a frame 1410 in which the edges of the frame where the flexible fingertip material is embedded is depicted with a domed top.

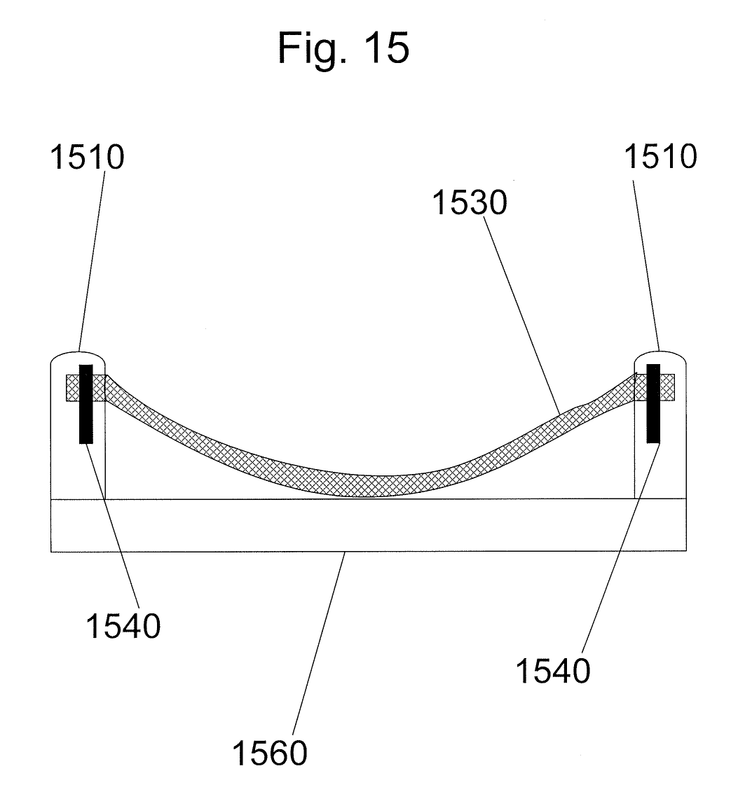

FIG. 15 is a side, cut-away view of a single key assembly wherein a flexible fingertip material 1530 is embedded in a frame 1510 and a pin construct 1540 is used to anchor the flexible fingertip material 1530 in the frame 1510. The pins 1540 are positioned at regular intervals around the frame.

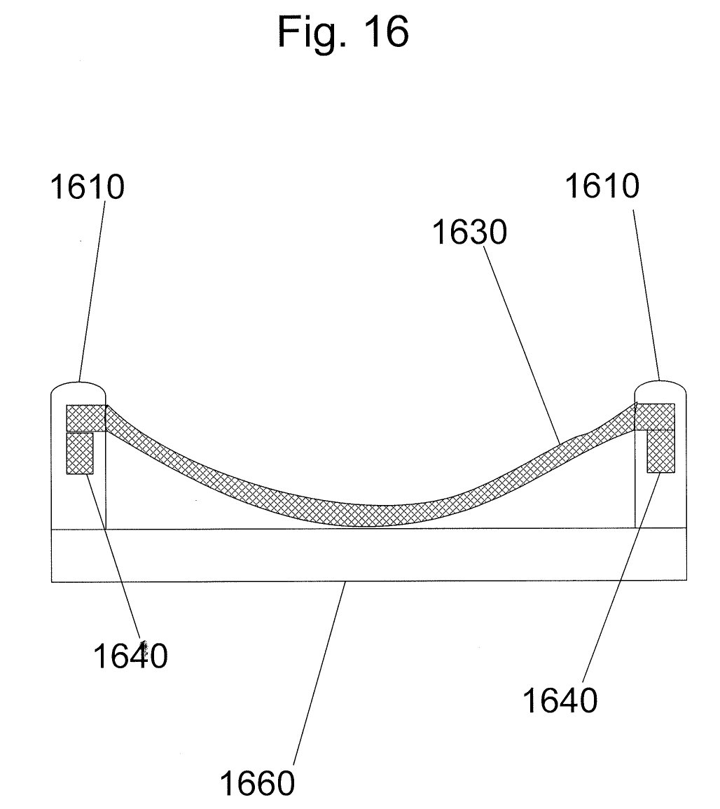

FIG. 16 is a side, cut-away view of a single key assembly wherein a flexible fingertip material 1630 is embedded in a frame 1610 wherein the edge of the flexible fingertip material forms an “L” shape inside the frame 1610 to establish a structurally-enhanced anchor within the frame.

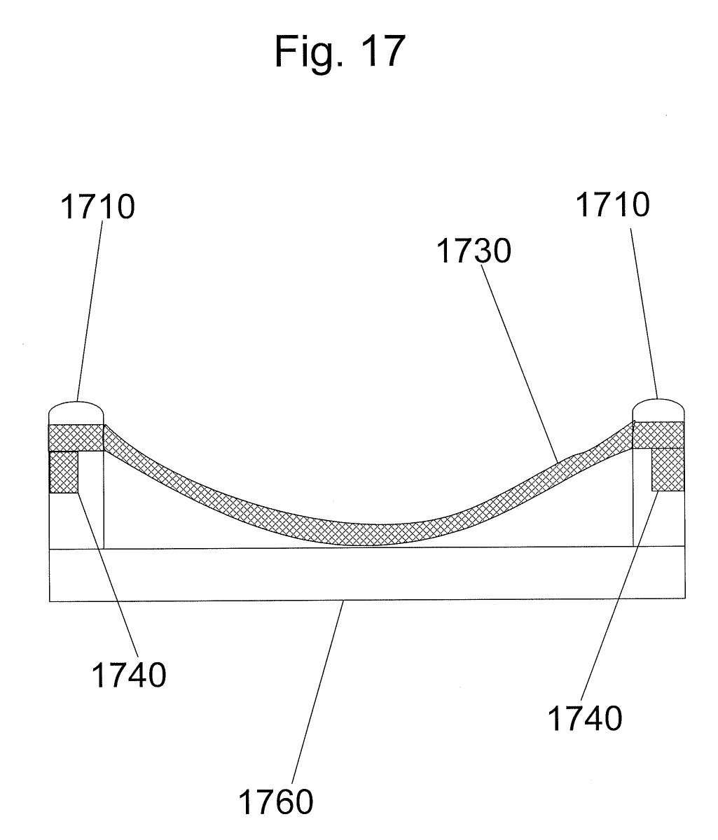

FIG. 17 is a side, cut-away view of a single key assembly wherein a flexible fingertip material 1730 is embedded in a frame 1710 wherein the edge of the flexible fingertip material forms an “L” shape that extends through the frame 1710 to the exterior side of the frame to establish a structurally-enhanced anchor on the frame.

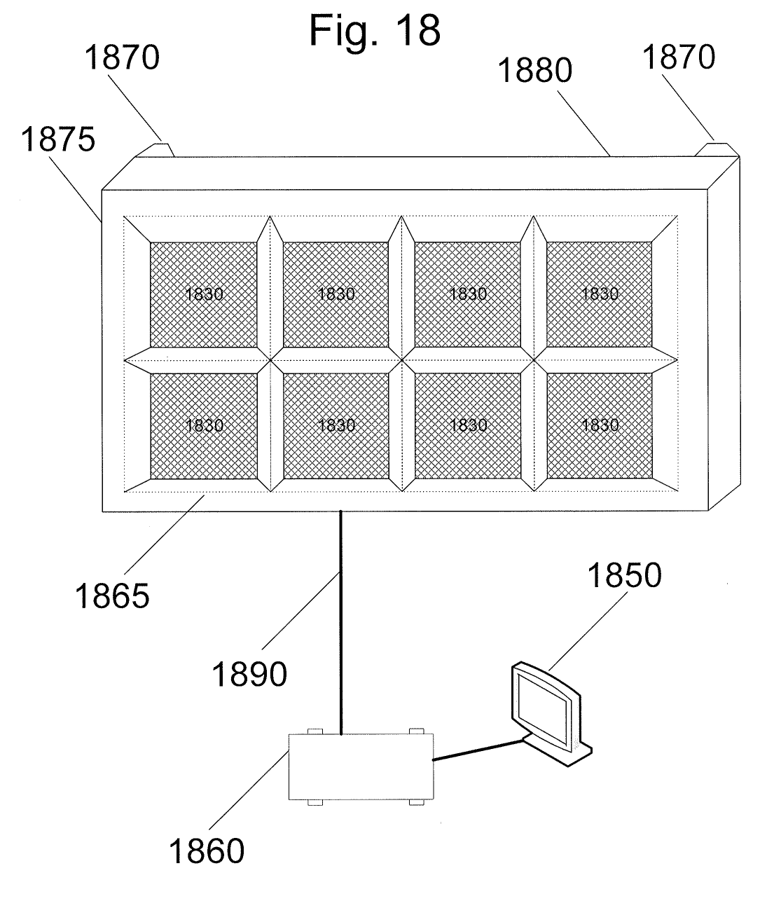

FIG. 18 is a view of a stand-alone keypad or keyboard 1875 with an eight-key array arranged in two rows by four columns of a multi-gesture trampoline key assembly 1865 in a case 1880 with feet 1870 which keypad or keyboard is attached wired or wirelessly 1890 to a tower component of a personal computer 1860 which is attached to a personal computer monitor 1850. This depiction could equivalently depict a full standard QWERTY keyboard array of multi-gesture trampoline keys as discussed above in the Summary of Invention section above. In this implementation, a flexible fingertip material 1830 is clear or transparent, and the PSL component underneath the fingertip material areas 1830 incorporates a display capability such that then-current value resultant from a contact of the flexible fingertip material 1830 with the underlying PSL component area is displayed in that underlying PSL component area such that it is visible to the user of the keyboard.

An alternative to this assembly design is to intersperse viewing areas between the keys and/or rows of keys as, for instance, discussed in relation to FIGS. 6, 7, 10 and 11 above. The relative dimensions of the keyboard to the PC and monitor are not to scale in order to better depict the components of the keyboard for purposes of this figure. The dimension of the keyboard, if implemented as a QWERTY keyboard, is somewhat comparable to the dimensions of a standard desktop QWERTY keyboard.

Alternatively, the tower component 1860 can comprise any type of device that sends commands, data and/or media content to a separate display (or monitor) device, including, for instance, a server, a router or a computing component, including, for instance, a computing component sending commands, data and media to for wearable or heads-up displays or portable displays.

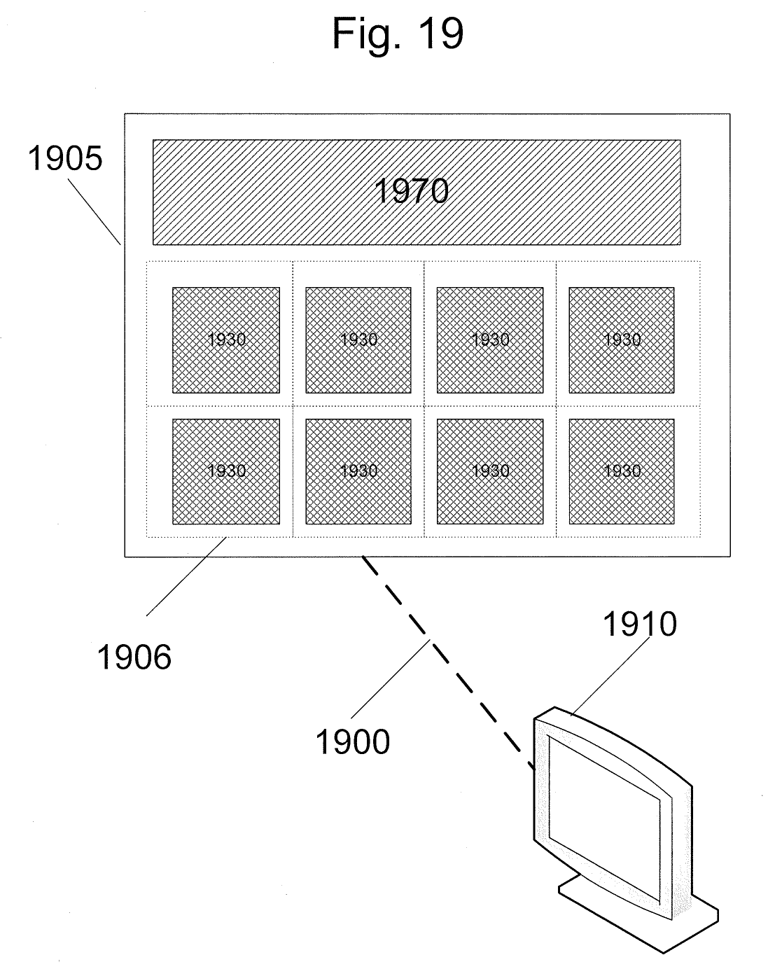

FIG. 19 is a view of a wireless remote control device 1905 with an eight-key array arranged in two rows by four columns of a multi-gesture trampoline key assembly 1906 which remote control also includes a display area 1970 and which remote control device signals wirelessly 1900 (via infrared, WiFi, Bluetooth or other wireless communication standard) to a television display/monitor 1910 directly or by way of a third device such as a cable or wife router, DVR, laptop, server or other device that is acting in whole or in part as a controller and/or content distribution system for the television display/monitor. This depiction could equivalently depict a full keypad array for a TV or other device remote control with the requisite number of multi-gesture trampoline keys. In this implementation, a flexible fingertip material 1930 is clear or transparent, and the PSL component underneath the fingertip material areas 1930 incorporates a display capability such that then-current value resultant from a contact of the flexible fingertip material 1930 with the underlying PSL component area is displayed in that underlying PSL component area such that it is visible to the user of the keyboard and/or displayed in the display area 1970.

An alternative to this assembly design is to intersperse viewing areas between the keys and/or rows of keys as, for instance, discussed in relation to FIGS. 6, 7, 10 and 11 above. The relative dimensions of the remote control 1905 to the television set 1910 is not to scale in order to better depict the components of the keyboard for purposes of this figure. The communication with the television set can be implemented such that the remote control is communicating wirelessly to a third device such as a laptop or personal computer, a wireless router or a control box for the television which third device subsequently directs associated commands to the television set.

The display area 1970 displays a variety of information, such as a group of command options for the system, system status, application or show-specific information, or a set of text being entered by the user via the keys prior to the text being sent over the system to one or more of the components external to the key assembly.

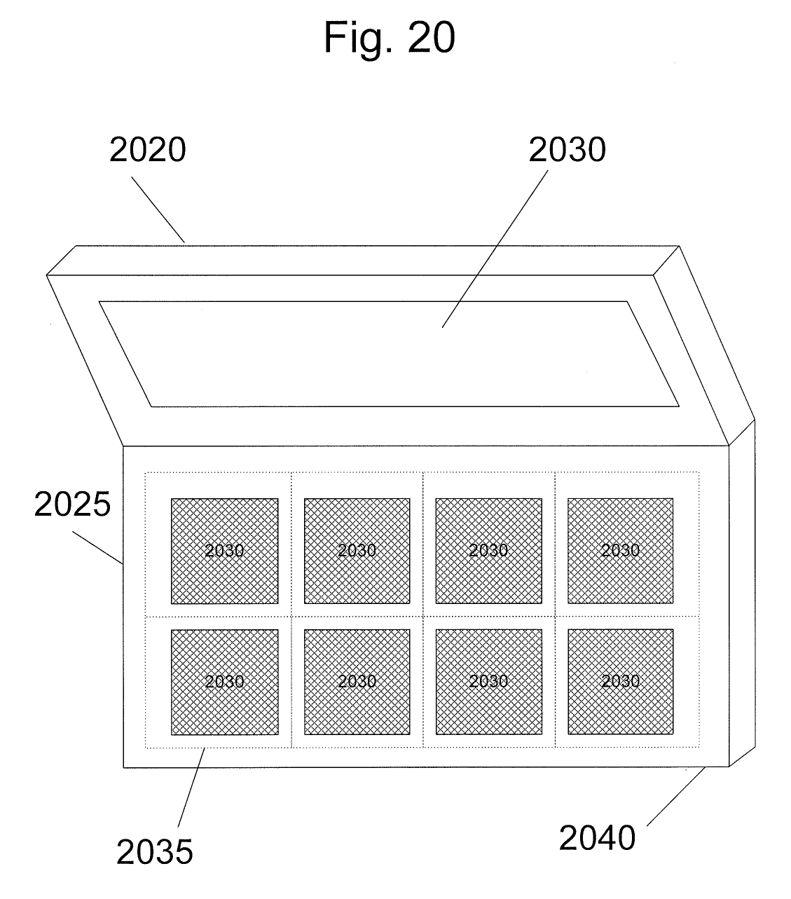

FIG. 20 is a depiction of a multi-gesture, trampoline key array 2035 embedded in a flip-top device 2025 design similar to a laptop computer, a flip phone, a netbook or other similar device wherein the device has a flip-top 2020 with a main display 2030 and a keyboard integral to and part of the lower portion the device's case 2040. Other device designs that incorporate an array of multi-gesture, trampoline keys can be flat, touchscreen devices such as tablet personal computers and rectangular smartphones with no hinges and with or without an area on the surface dedicated to a physical keyboard distinct from the touchscreen display.

While this FIG. 20 shows a two row by four column array for multi-gesture, trampoline keys, this depiction could equivalently depict a full standard QWERTY keyboard array of multi-gesture trampoline keys as discussed above in the Summary of Invention section above. Further, in the implementation depicted in this FIG. 20, the flexible fingertip material 2030 is clear or transparent, and a PSL component underneath the fingertip material areas 230 incorporates a display capability such that then-current value resultant from a contact of the flexible fingertip material 2030 with the underlying PSL component area is displayed in that underlying PSL layer area such that it is visible to the user of the keyboard. An alternative to this assembly design is to intersperse viewing areas between the keys and/or rows of keys as, for instance, discussed in relation to FIGS. 6, 7, 10 and 11 above.

Alternatively, this device can have a non-flip display construction, and the device can consist of any type of device that incorporates both a keypad and a display, such as a smartphone, a tablet computer, a laptop computer, a remote control, an automobile (or other driving vehicle) dashboard or control panel, an airplane (or other flying vehicle) control panel (in the cockpit, by the passenger seats), or a household or business appliance (such as a refrigerator, microwave, printer, copier, desktop phone).

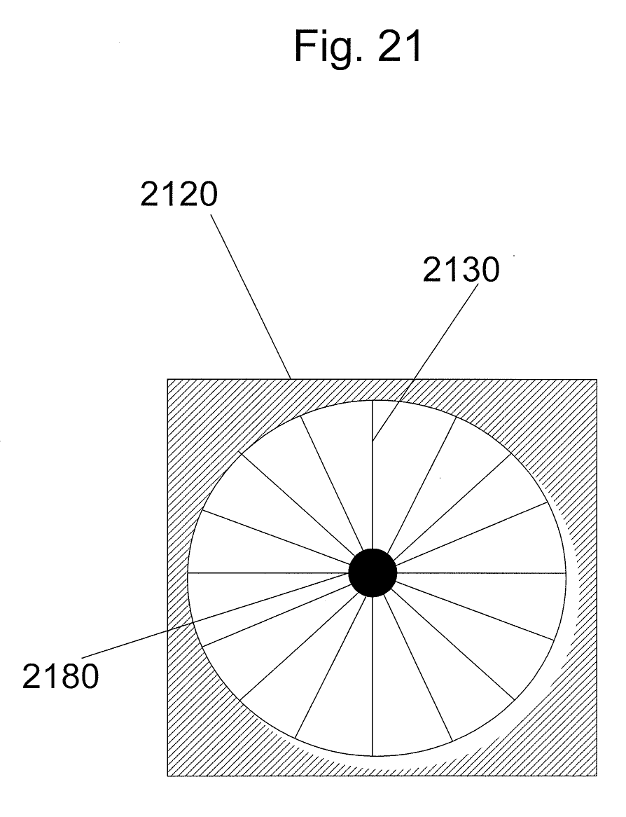

FIG. 21 is a top view of a single key external frame 2120, a flexible finger press material 2130, a central physical nub 2180 which central physical nub is more fully described above and which central physical hub, for key assemblies wherein the PSL component is a capacitive touchscreen designed for direct fingertip contact recognition, is constructed (or made with a coating) of a silicone that mimics the natural conductive qualities of the human finger. In this FIG. 21, the flexible fingertip material 2130 comprises one or more strings that connect the frame and the central physical hub 2180, and which strings hold the central physical nub 2180 in a resting position above the PSL and centrally in relation to the sides of the frame, allowing for the motion of the central physical hub to move downwards and across the PSL layer by pressure of the fingertip.

The shape of the frame surrounding the flexible fingertip surface can be symmetrical or asymmetrical depending on the needs and constraints of a specific device implementation. For instance, these figures, a square or circular flexible, fingertip surface area, whereas for certain mobile device or keyboard contexts, as two examples, either a set of asymmetrical keys is preferred or a mix of sizes and shapes of keys is preferred (as, for instance, on a standard desktop keyboard wherein certain keys such as the “space” and “return” keys are larger than the keys labeled with letters from, for instance, the English alphabet. Asymmetrical key design include the shape of a rectangle and the shape of an oval.

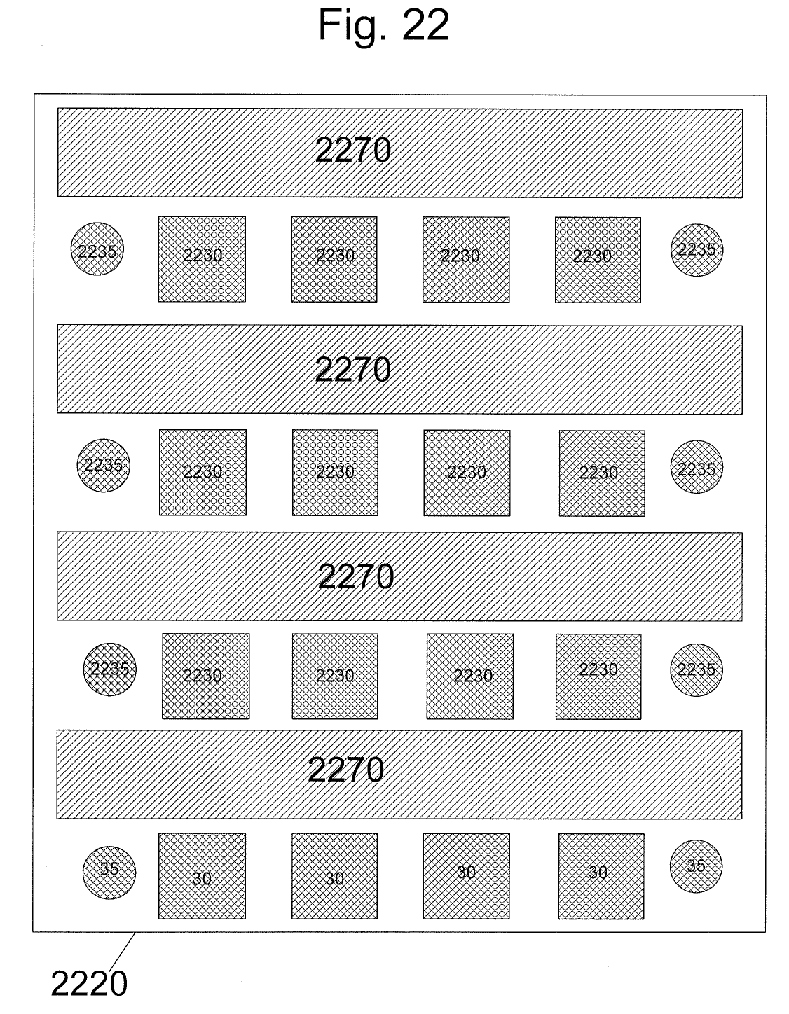

FIG. 22 is a top view of a multi-gesture trampoline key array wherein four rows of keys 2230 (square or rectangular), 2235 (circular or oval) are positioned inside a frame 2220 that has four parallel viewing windows 2270 that provided a direct, unimpeded line-of-sight view to the display(s) located below the frame at least in the area underneath such viewing windows 2270. Beneath each viewing window 2270 are located a single row of six keys wherein the middle four keys 2230 have one common set of surface dimensions and the two keys 2235 on the right and left of those middle four keys 2230 have a different surface dimension for their flexible fingertip material.

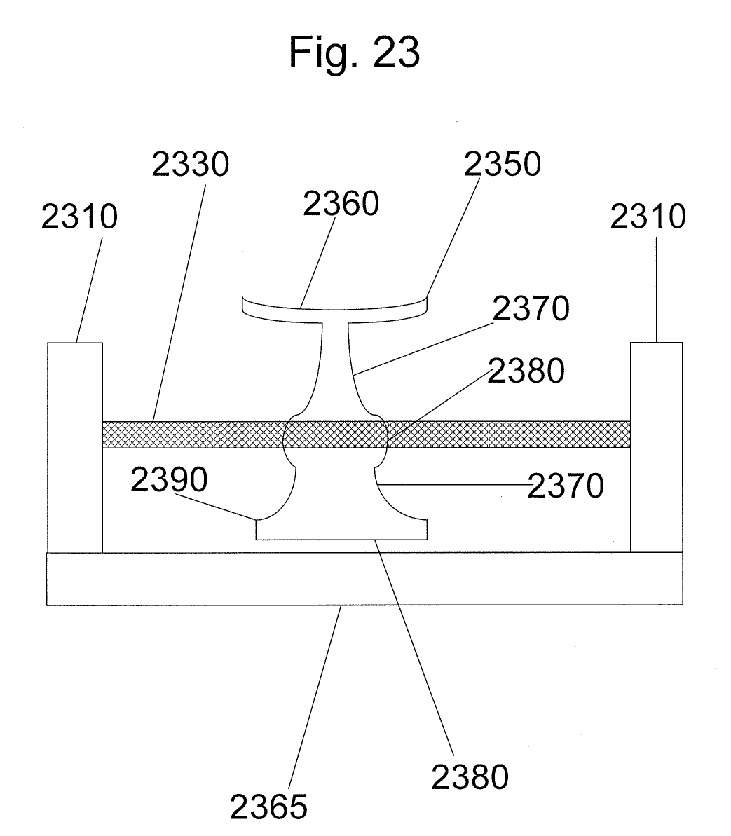

FIG. 23 is a side view of a single multi-gesture trampoline key wherein a key is constructed of a frame 2310, a flexible material 2330 comprising of a single band of stretchable fabric (or rope or other stretchable material with a circular, oval or other cross-sectional design and a surface that allows for slippage along the length of the material) and a physical nub 2350. The single band of stretchable material 2330 is located above a PSL component 2365, and along a single axis of the frame 2310 and centered in that frame area. The physical nub 2350 is designed such that a top surface 2360 is a rounded, somewhat rectangular, concave surface with a neck 2370 that has a hole 2380 through the neck through which the stretchable band 2330 runs and that encircles the stretchable band 2330 thereby allowing the nub 2350 to slide along the length of the stretchable band 2330 based on directional pressure on the top surface 2360 of the nub 2350. The physical nub 2350 further has a bottom surface 2380 that is flat such that when the top surface 2360 of the nub is depressed by a finger, thereby deforming the stretchable band 2330 downwards, the entire bottom surface area 2380 of the nub 2350 contacts the top surface of the PSL component 2365 located beneath the bottom surface area 2380 of the nub 2350. The contact point will be a line or arc if the user moves the nub 2350 by sliding the nub 2350 along a portion of the length of the stretchable band 2330 (and/or by moving the nub in any other direction relative to the stretchable band 2330) and, simultaneously pressing down on the top surface 2360 of the nub 2380 sufficient to place the bottom surface 280 of the nub 250 in contact with the top surface of the PSL component 2365. The start point of the line or arc of contact is determined by the place of initial position of the bottom surface 2380 of the nub 2350 within the key frame 2310 when contact is made between the bottom surface 2380 of the nub 2350 and the top surface of the PSL component 2365. The end point of the line or arc of contact is determined by the position of the bottom surface 2380 of the nub 2350 when that contact is terminated by the user releasing downward pressure on the top surface 2360 of the nub 2350, which results in the return of the stretchable band to its non-deformed, baseline position thereby lifting the nub 250 sufficiently to terminate the contact of the bottom surface 2380 of the nub 2350 with the top of the PSL component 2365.

As earlier described, all or part of the physical nub 2350 may consist of capacitive (or conductive) material (or a coating thereof) in the case that the touch-sensitive component incorporates a capacitive system for registering user interaction, as in, for instance, the Apple iPhone models. Such a capacitive material is commercially available in a number of products for activating the iPhone screen as an alternative to a direct finger press in such products as touchscreen styluses and touchscreen-enable fingertips on gloves.

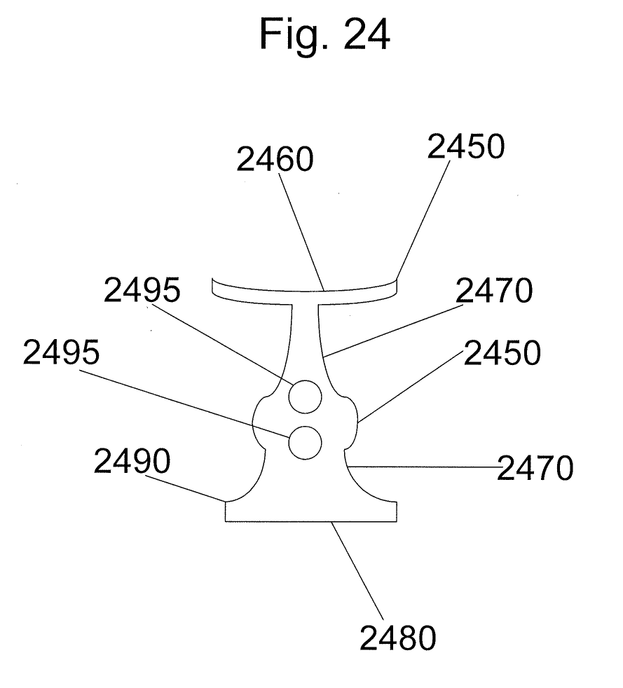

FIG. 24 is a cross-sectional view of just a physical nub 2450 (similar to the nub as described in FIG. 23 above), wherein the physical nub 2450 comprises a top surface 2360 that is a rounded, somewhat rectangular, concave surface with a neck 2370. The neck, in this implementation, has two holes 2395 that each encircle a separate stretchable band (not shown, and located vertically one above the other) which holes allow movement of the nub 2350 along the length of the stretchable bands. The physical nub 2350 further has a bottom surface 2380 that is flat such that when the top surface of the nub is depressed, thereby deforming the stretchable band downwards, the bottom surface's bottom area is in contact with the touch sensitive area of the PSL component located below the nub 2350.

The primary purpose of two bands is to stabilize the nub 2350 in its upright orientation while still allowing the nub to slide along the length of the stretchable band(s). Another purpose of a system using two bands is to provide additional resistance to a downward press on the nub, and more force returning the nub to its position out-of-contact with the PSL component. Many of these purposes can also be accomplished with a single stretchable band that has a non-circular cross-section, and/or multiple parallel bands located non-vertically in relation to each other, provided that the nub has correspondingly designed holes for the stretchable band(s).

When an implementation of this invention includes a need for the physical nub to automatically return to a position equidistant from the sides of the frame along the axis of the bands, the second band can be fixably attached to the physical nub, such that the nub slides along the first band, and the second band stretches along the axis in the direction the nub is moved, and returns the nub to the center position once the finger releases directional pressure on the nub along the axis of the bands. Alternatively, and for instance in a single band context, two mechanical springs can be interposed on the band, one spring on each side of the nub, whereby one of the springs compresses as the user moves the nub in the direction of the spring along the axis of the band, and the spring decompresses on release of the directional finger pressure, thereby returning the nub to a centered position along the axis of the band.

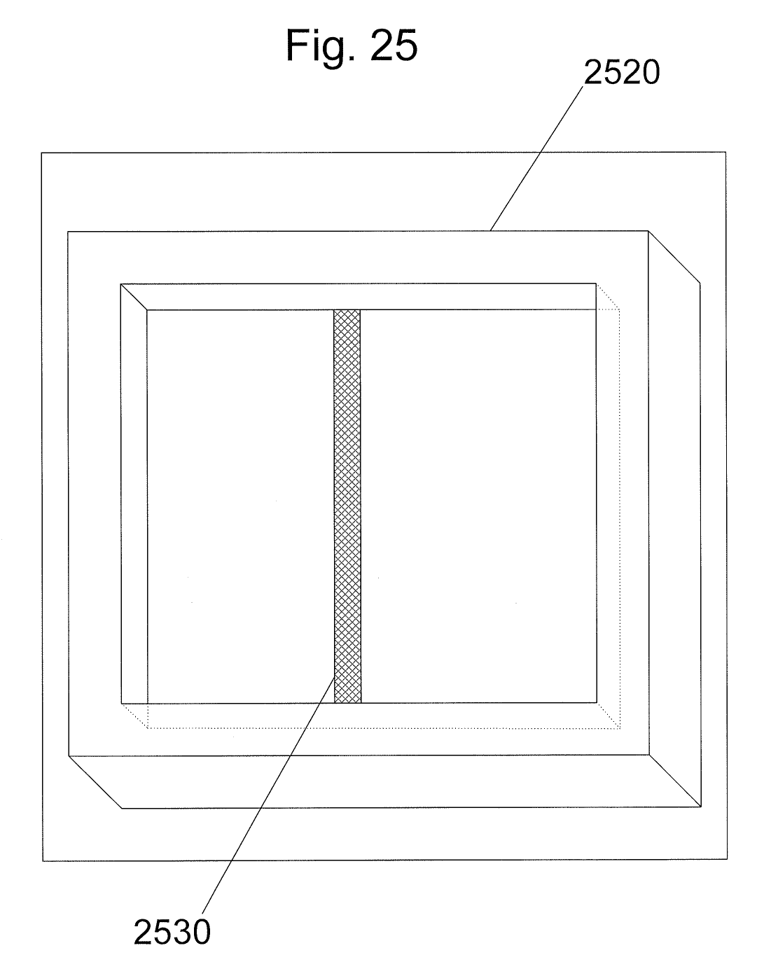

FIG. 25 is a top view of a single key structure (similar to that shown in FIG. 3 above), provided, however, that the flexible material comprises a single band that runs along one axis of the frame 2520 and centrally located in relation to the sides of the frame 2520 to which the band 2530 is not attached. In a different embodiment, similar to as described in FIG. 24 above, there are two separate bands 2530 located one above the other. The cross-section of the band(s) 30 is circular in this embodiment, but may be oval or alternative shapes in other embodiments to match the shape of the hole(s) in the physical nub described in FIGS. 23 and 24.

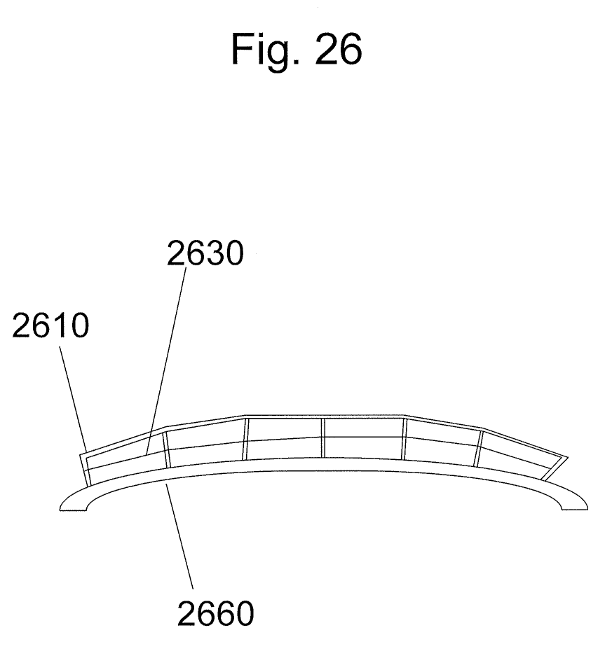

FIG. 26 is a side view of an implementation of the multi-gesture keypad wherein a frame 2610 is formed to follow the surface of a PSL component 2660 that has a curved top surface and the flexible material 2630 comparably conforms to the shape of the frame 1610 such that the flexible material is positioned above the top surface of the PSL component 2660 at an even height above the surface of the PSL component.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventor for carrying out the invention. Variations of those preferred embodiments may become apparent to those of ordinary skill in the art upon reading the foregoing description. The inventor expects skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. An information input device, comprising:
an external case;
a touchscreen component located on the top surface of the device; and
an assembly of keys above the touchscreen wherein the assembly of keys comprises:
a frame at the perimeter of the array of plurality of keys device and which frame surrounds each key, and
a flexible material reaching across the open areas of the frame wherein the frame supports the surface of flexible material at height above the touchscreen component; and
wherein the contact of the flexible surface within a frame area with the touchscreen surface is recognized by the touchscreen components of the information input device as a touch of the touchscreen.

2. The invention as in claim 1 wherein the frame comprises a rigid material.

3. The invention as in claim 1 wherein the frame is integral to the external case.

4. The invention as in claim 1 wherein the frame is detachable from the external case.

5. The invention as in claim 1 wherein the frame comprises an external frame surrounding the key array and an internal frame surrounding each key, and wherein the external frame and the internal frame are integrally constructed.

6. The invention as in claim 1 wherein the flexible material contains a physical nub at its center wherein the physical nub extends below the surface of the flexible material, and the lower surface of the physical nub is a flat surface parallel to and located above the touchscreen component.

7. The invention as in claim 6 wherein the physical nub extends above the surface of the flexible material.

8. The invention as in claim 7 wherein the physical nub extends above the surface of the flexible material and above the frame.

9. The invention as in claim 1 wherein the touchscreen component is a touch sensitive or pressure sensitive surface located underneath the flexible materials within the frame.

10. The invention as in claim 1 wherein the frame areas contain both a set of key areas wherein the flexible material is located and framed areas without flexible materials.

11. The invention as in claim 1 wherein the information input device is integral to a computing device from the set of computing devices comprising of: mobile phones, remote controls, laptop computers and handheld computing devices.

12. The invention as in claim 1 wherein the flexible material has an open area at its center sufficient to permit the contact of a portion fingertip to the touchscreen component when downward directional fingertip pressure is imposed on the flexible material.

13. The invention as in claim 1 wherein the flexible material comprises of a single band of material extending along a single axis of the framed area, wherein the axis is centered in the key area, and wherein the single band of material enables movement along an opposing axis in addition to the primary axis.

14. The invention as in claim 1 wherein a physical nub is fitted on the band of stretchable material such that the physical nub is moveable lengthwise along the single band of material extending along a single axis of the framed area.

15. The invention as in claim 14 wherein the physical nub has at least one of the group of surfaces on the top of the physical nub comprising of: a rounded, a rectangular and a concave surface at the top, and a neck below the surface which neck is sufficiently long such that the underneath side of the top surface component is at a height above the top surface of the frame of the key.

16. The invention as in claim 15 wherein the physical nub has a flat surface at the bottom such that the bottom flat surface contacts the touchscreen component when downward force is exerted on the physical nub.

17. The invention as in claim 1 wherein the touchscreen component incorporates a capacitive system for recognizing user interface actions.
